(19) United States
(12) Patent Application Publication
(10) Pub. No.: US 2019/0161064 A1
(43) Pub. Date: May 30, 2019

(54) DETERMINING A MAXIMUM ADHESION LIMIT

(71) Applicant: ZF Friedrichshafen AG, Friedrichshafen (DE)

(72) Inventors: Robert ZDYCH, Friedrichshafen (DE); Heinz-Joachim GILSDORF, Donnersdorf (DE); Volker WAGNER, Ravensburg (DE); Matthias SCHLEGEL, Blaustein (DE); Lara Ruth TURNER, Immenstaad (DE); Julian KING, Rankweil (AT)

(21) Appl. No.: 16/318,758

(22) PCT Filed: Jun. 27, 2017
(86) PCT No.: PCT/EP2017/065807

§ 371 Date: Jan. 18, 2019

(30) Foreign Application Priority Data
Jul. 29, 2016 (DE) 10 2016 214 065.5

(51) Int. Cl. B60T 8/172; B60K 28/16; B60W 40/064; B60W 30/02

(52) U.S. Cl. CPC B60T 8/172; B60K 28/16; B60T 2230/02; B60W 30/02; B60T 2210/12; B60W 40/064

(57) ABSTRACT

A method for determining a maximum adhesion limit between a tire and a substrate on which the tire is running in a longitudinal direction. The method includes detecting an instantaneous slip of the tire; detecting an instantaneous longitudinal force on the tire; determining an instantaneous coefficient of adhesion; forming a tuple from the detected slip and determined instantaneous coefficient of adhesion; and determining the adhesion limit. The adhesion limit is determined on the basis of the slope of a straight line passing through the origin and the tuple, if the slip is less than a first threshold value, or on the basis of the slope of a tangent passing through the tuple, if the slip is between the first threshold value and a second threshold value, or directly on the basis of the instantaneous coefficient of adhesion, if the slip is greater than the second threshold value.

This application is a National Stage completion of PCT/EP2017/065807 mailed Jun. 27, 2017, which claims priority from German patent application serial no. 10 2016 214 065.5 filed Jul. 29, 2016.

### FIELD OF THE INVENTION

The invention relates to the determination of a maximum adhesion limit μₘₐₓ which indicates a maximum force that can be transmitted between a tire and a substrate.

### BACKGROUND OF THE INVENTION

A motor vehicle with four tires drives on a substrate. If a longitudinal force, in particular an acceleration force or a braking force, acts between one of the fires and the substrate, the circumferential speed of the tire usually differs from the travel speed of the motor vehicle and some slip occurs. If a transverse force acts upon the fires, for example when the motor vehicle is driving round a curve, then the rotational plane of the fire does not coincide with the travel direction of the tire and there is a sideslip angle that is not equal to zero. The transverse force can act in both directions and the sideslip angle can occur on a steered tire or an unsteered tire.

The slip and sideslip angle can be denoted in summary fashion as a λ-value. A maximum force that can be transmitted between the fires and the substrate is known as the adhesion limit and generally depends on the λ-value and the maximum possible coefficient of adhesion μmax. In this case, the relationship between the λ-value and the coefficient of adhesion μ is as a rule only linear in part of the range concerned. If the force to be transmitted between the fires and the substrate exceeds the adhesion limit, there is a risk that control over the motor vehicle may be lost.

DE 10 2012 217 772 A1 proposes to determine the maximum adhesion limit for two different λ-value ranges. If the λ-value is small, then the determination of the maximum adhesion limit μmax should be based on the slope of a straight line through the origin that passes through a tuple of the current λ-value and the current coefficient of adhesion μ. In contrast if the λ-value is large, then the determination of the maximum adhesion limit μmax should be based on the tuple of the current λ-value and the slope of a tangent.

### SUMMARY OF THE INVENTION

A purpose of the present invention is to indicate supplements concerning an improved technique for the reliable determination of the maximum adhesion limit. This objective is achieved by the objects of the independent claims. The subordinate claims define preferred embodiments.

[symbol]

A tire rolls on a substrate. A first method for determining an adhesion limit between the tire and the substrate, in the longitudinal direction of the tire, comprises steps of determining an instantaneous slip of the tire; determining an instantaneous coefficient of adhesion; forming a tuple from the slip determined and the instantaneous coefficient of adhesion; and from that, determining the maximum adhesion limit. In this case the maximum adhesion limit is determined on the basis of the slope of a straight line through the origin that passes through the tuple, if the slip is smaller than a first predetermined first threshold value, or on the basis of the slope of a tangent through the tuple if the slip is between the first and a second threshold value, or directly on the basis of the instantaneous coefficient of adhesion if the slip is greater than the second predetermined threshold value.

It has been recognized that above a certain slip, a characteristic curve of the coefficient of adhesion against the slip has a negligible slope. Thus, in this range the maximum adhesion limit can be determined in a simpler way. In contrast to the known prior art, the characteristic curve of the coefficient of adhesion against the slip can be divided into three parts instead of two pads. In this way a direct further development of the proposals disclosed in DE 10 2012 217 772 A2 can be realized. The present invention is understood as a direct further development of the publication.

In the range above the second threshold value, the maximum adhesion limit can in particular be taken as equal to the instantaneous coefficient of adhesion. This gives an approximation which is accurate enough for most purposes and can be carried out quickly and efficiently. Inaccuracies that could arise in the determination of the slope of the characteristic curve in this range on the basis of a tangent slope are avoided, and the reliability of the friction information as a whole is increased thereby.

The instantaneous coefficient of adhesion can be determined as a quotient of a directly measured tangential force and a directly measured tire normal force on the tire. The direct measurement of the tangential force or of the normal force acting on the tire is usually uncomplicated and can already be implemented in the motor vehicle for other reasons.

In another embodiment the instantaneously effective coefficient of adhesion can also be determined on the basis of a model. The model can in particular comprise a calculation model, which works on the basis of a yaw rate of the motor vehicle, a rotational speed of the tire or of another tire, or on the basis of accelerations. In a conventional motor vehicle the variables can be detected and determined by means of an already existing sensor system, so that the instantaneously effective coefficient of adhesion can be determined simply and accurately.

In a further embodiment a longitudinal force acting instantaneously on the tires is determined and the coefficient of adhesion is determined as the quotient of the longitudinal force and a normal force.

The first method can be transferred to a transverse force on the tire. A second method for determining a maximum adhesion limit between the tire and the substrate, in the transverse direction of the tire, comprises steps of detecting an instantaneous sideslip angle of the tire; determining an instantaneous coefficient of adhesion; forming a tuple from the sideslip angle detected and the instantaneously effective coefficient of adhesion determined; and determining the maximum adhesion limit. In this case the maximum adhesion limit is determined on the basis of a straight line from the origin that passes through the tuple if the sideslip angle is smaller than a first predetermined threshold value, or on the basis of the slope of a tangent passing through the tuple if the sideslip angle is between the first and a second threshold value, or directly on the basis of the instantaneously effective coefficient of adhesion if the sideslip angle is above the second threshold value.

The procedure for the second method corresponds essentially to the first method described above, so that variants or embodiments can be exchanged directly or correspondingly between the two methods. A method can also be provided for the universal determination of the forces directed longitudinally and/or transversely on the tire, or in succession on several tires of a motor vehicle.

In one embodiment a longitudinal force acting instantaneously on the tire is determined and the coefficient of adhesion is determined as the quotient of the longitudinal force and a normal force.

A first device for determining a maximum adhesion limit between a tire and a substrate over which the tire is rolling, in the longitudinal direction of the tire, comprises a first interface for detecting an instantaneous slip of the tire; a second interface for determining an instantaneous coefficient of adhesion; and a processing device designed to form a tuple from the slip detected and the coefficient of adhesion determined and to determine the maximum adhesion limit. In this case the adhesion limit is determined on the basis of the slope of a straight line through the origin that passes through the tuple if the slip is smaller than a first predetermined threshold value, on the basis of the slope of a tangent passing through the tuple if the slip is between the first and a second threshold value, or directly on the basis of the instantaneously effective coefficient of adhesion if the slip is above the second threshold value. Preferably, a further interface is provided for making available the adhesion limit determined.

A second device for determining an adhesion limit between a tire and a substrate over which the tire is rolling, in the transverse direction of the tire, comprises a first interface for detecting an instantaneous sideslip angle of the tire; a determination device for determining an instantaneous coefficient of adhesion; and a processing device designed to form a tuple between the sideslip angle detected and the coefficient of adhesion determined; and for determining the maximum adhesion limit. In this case the maximum adhesion limit is determined on the basis of the slope of a straight line through the origin that passes through the tuple if the sideslip angle is smaller than a first predetermined threshold value, on the basis of the slope of a tangent passing through the tuple if the sideslip angle is between the first and a second threshold value, or directly on the basis of the instantaneously effective coefficient of adhesion if the sideslip angle is above the second predetermined threshold value. Preferably, a further interface is provided for making available the adhesion limit determined.

The two devices essentially correspond with one another, so that variants or embodiments can be exchanged directly or correspondingly between the devices. A device can also be provided for the universal determination of the forces directed longitudinally and/or transversely on the tire, or in succession on several tires of a motor vehicle.

The interfaces can each for example be in the form of electric, electronic, computational or logical interfaces. The example embodiments and features applicable to the method can also be applied mutatis mutandis to the devices, and conversely. The processing device of one of the devices can comprise in particular a programmable microcomputer, which is preferably designed to carry out at least part of one of the methods described. For that purpose the method concerned can take the form of a computer program product.

The method and the devices can be used to determine the respective maximum adhesion limits in an advantageous manner, so that valuable information for the assessment of a driving condition or for controlling the motor vehicle can be made available. For example a warning can be emitted if forces acting upon the tires threaten to reach the maximum adhesion limit, perhaps if the forces are less than a predetermined amount lower than the maximum adhesion limit. In another embodiment, in the same eventuality the motor vehicle can be controlled so as to avoid reaching the maximum adhesion limit, perhaps by braking or accelerating the tire or another tire, changing a steering angle or adopting some other measure.

A motor vehicle comprises a tire and one of the above-described devices. Usually the motor vehicle has several tires, for example two if it is a motorcycle, four if it is a passenger car or a light utility vehicle, and four or more tires if it is a larger or heavier utility vehicle. Multiple tires that together form a wheel can be regarded as one tire. The adhesion omit can be determined tire by tire for all the tires present, or for only some of them. As has been described, the adhesion limits can be determined both in the longitudinal direction and in the transverse direction of the tire concerned.

### BRIEF DESCRIPTION OF THE DRAWINGS

Embodiments of the invention will now be described in greater detail with reference to the attached figures, which show:

FIGS. 1, 1A: A tire on a substrate;

FIG. 2: A characteristic curve between the slip or sideslip angle of a tire and its coefficient of adhesion;

FIG. 3: A flow chart of a method for determining a maximum coefficient of adhesion of a tire; and

FIG. 4: A schematic representation of a device for determining the maximum coefficient of adhesion.

### DETAILED DESCRIPTION OF THE PREFERRED EMBODIMENTS

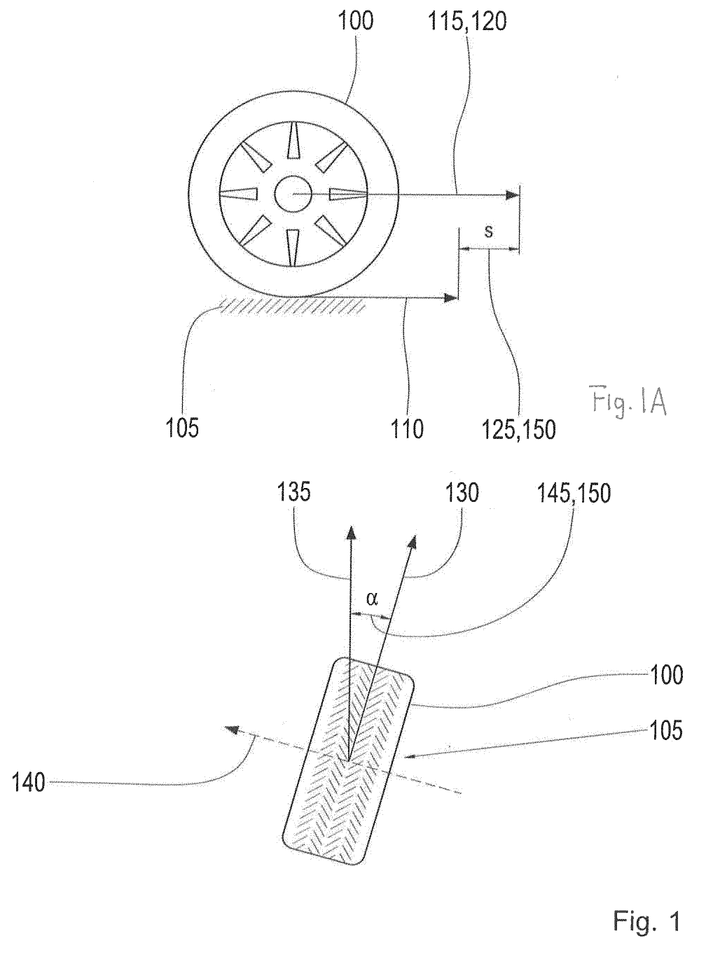

FIGS. 1 and 1A show a tire 100 on a substrate 105, viewed from the side and from above. The tire 100 is usually fitted on a wheel; in this description, however, we are mainly concerned with the frictional behavior between the tire 100 and the substrate 105, so that for example in order to consider the driving behavior of a motor vehicle, the tire 100 can be regarded as synonymous with a wheel.

In the side view (FIG. 1A) a circumferential speed 110 and a longitudinal speed 115 are shown. The longitudinal speed 115 is directed in a longitudinal direction 120 which is perpendicular to a rotational axis of the tire 100 and is usually parallel to the substrate 105. A difference between the speed 110 and 115 is produced by slip 125, which can be denoted as s.

In the view from above (FIG. 1), a rotational plane 130 and a travel direction 135 are shown. The rotational plane 130 is perpendicular to a transverse direction 140, which extends parallel to the rotational axis of the tire 100. Between the rotational plane 130 and the travel direction 135 there is a sideslip angle 145 that can be denoted α.

In relation to a coefficient of adhesion between the tire 100 and the substrate 105, a slip 125 that depends on a force acting in the longitudinal direction 120 behaves similarly to the sideslip angle 145 that depends on a force acting in the transverse direction 140. Thus, in the explanations that follow a λ-value 150 is used as an overarching term for the slip 125 and the sideslip angle 145. Thus, an adhesion limit can be determined on the basis of the instantaneously effective coefficient of adhesion in relation to the longitudinal forces and the transverse forces in an analogous manner.

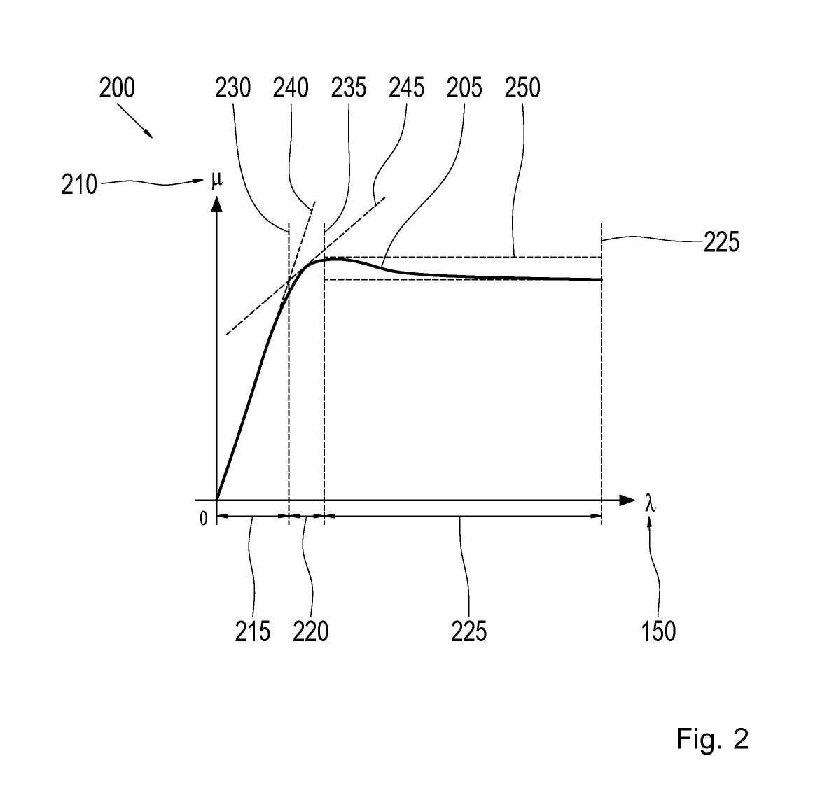

FIG. 2 shows a diagram 200 with a characteristic curve 205 between a λ-value 150 and a coefficient of adhesion 210, here denoted by μ. The characteristic curve 205 can be divided into a first range 125 starting at the origin (λ=0, μ=0), a second range 220 and a third range 225. Between the first range 215 and the second range 220 there is a first threshold value 230, and between the second range 220 and the third range there is a second threshold value 235.

An adhesion limit can be determined as a function of a slope of the characteristic curve 205. The slope differs in the three ranges 215 to 225. In the first range 215 the slope can be approximated by the slope of a straight line through the origin 240, which passes through the origin and a measurement point to which 205 extends. This measurement point is given as a tuple with the x-coordinate of an instantaneous λ-value 150 and a y-coordinate of an instantaneous coefficient of adhesion value 210. In the second range 220 the slope can better be determined by a tangent 245 at the measurement point. For this, a plurality of measurement points as close together as possible can also be considered. In the third range 225, for simplicity the slope can be regarded as approximately constant. In particular the adhesion limit can be taken as equal to the instantaneous coefficient of adhesion 210.

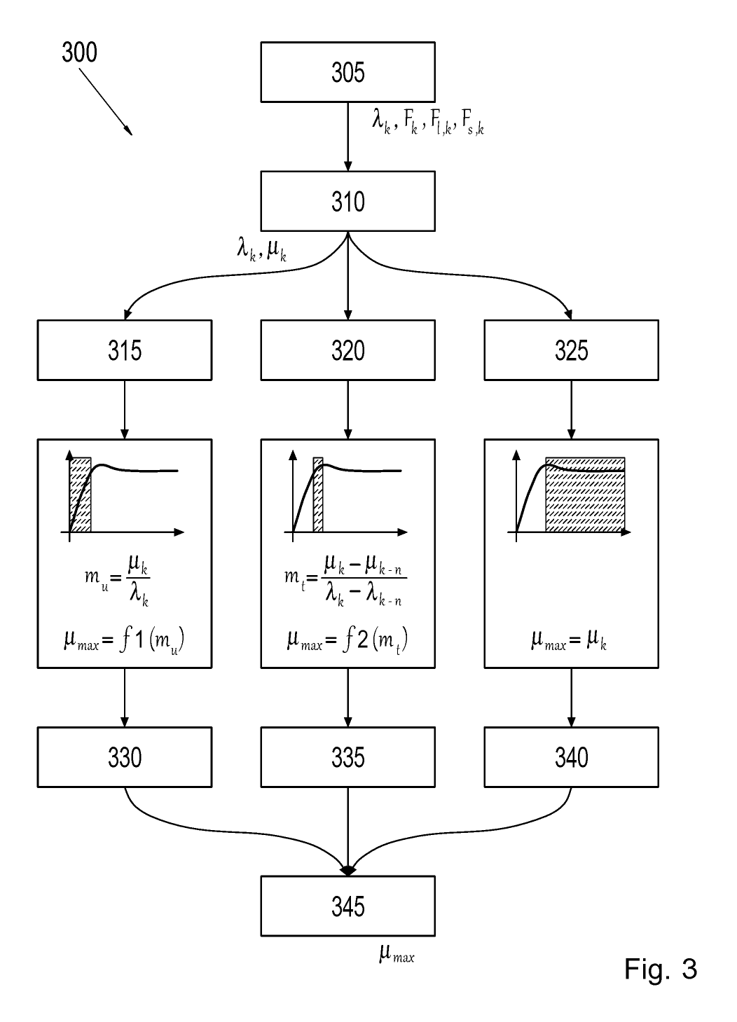

FIG. 3 shows a flow chart of a method 300 for determining the adhesion limit of a tire 100. In a step 305 one or more parameters of the tire 100 or a motor vehicle connected thereto are determined. In one embodiment, at a time-point k an instantaneous λ-value 150, a normal force F_{z, k} and a tire longitudinal force F_{l, k} or a tire lateral force F_{s, k} can be determined. In a step 310 the instantaneous coefficient of adhesion μₖ (210) is determined, for example as the quotient of the tangential force determined, i.e. the previously determined force in the longitudinal direction 120 or transverse direction 140, and the normal force. In another embodiment the coefficient of adhesion 210 can even be determined in some other way, perhaps by means of a calculation model. The calculation model can require a determination of the yaw rate of the motor vehicle, or a tire rotational speed of the tire 100 or that of another tire, or accelerations.

Thereafter, the λ-value 150 determined is evaluated in relation to the threshold values 230 and 235. In a first case 315, the λ-value 150 is in the first range 215, i.e. between the origin and the first threshold value 230. In a second case 320 the λ-value 150 is in the second range 220, i.e. between the first threshold value 230 and the second threshold value 235. In a third case 325 the λ-value 150 is above the second threshold value 235. If necessary the range 225 can be given an upper limit by a third threshold value 255. In which of the adjacent ranges 215 to 225 the λ-value 150 is located if it coincides with one of the threshold values, can be defined appropriately.

For the three cases 315 to 325 the positions of the respective ranges 215 to 225 in relation to the characteristic curve 205 and the determination of a slope m are indicated diagrammatically. In the first case 315 a slope mᵤ of a straight line through the origin is determined and in a step 330 the adhesion limit μₘₐₓ is determined by means of a function f1 on the basis of the slope mᵤ. In the second case 320 a tangent slope mₜ is determined and in a step 335 the adhesion limit μₘₐₓ is determined by means of a function f2 on the basis of the slope mₜ. In the third case 325 the slope can be taken to be constant, so that no determination is needed. In a step 340 the adhesion limit μₘₐₓ can be taken as equal to the instantaneously or currently effective coefficient of adhesion μₖ.

In a subsequent step 345 the adhesion limit μₘₐₓ determined can be made available, for example in order to evaluate a consideration or assessment of a driving condition of a motor vehicle to which the tire 100 is fitted, or to control the motor vehicle or the tire 100.

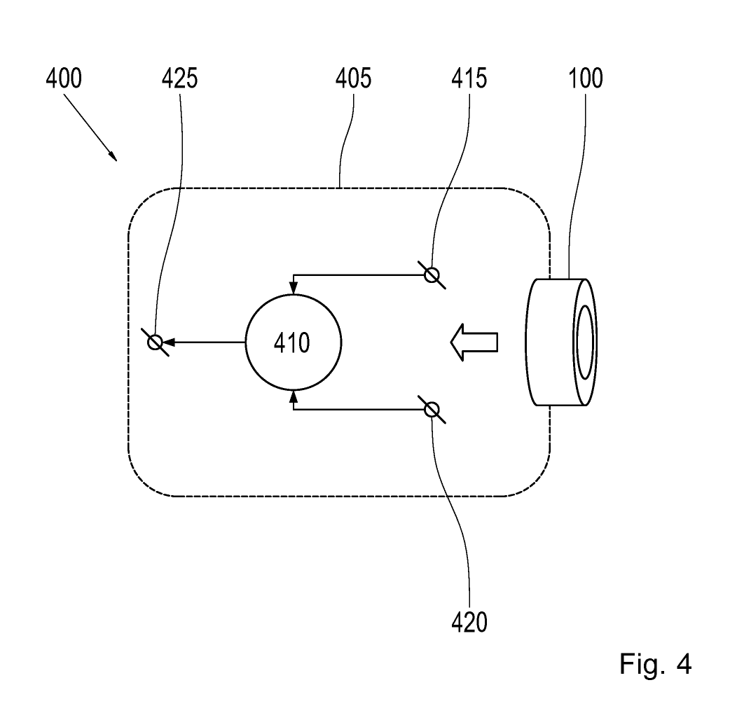

FIG. 4 shows a schematic representation of an example of a device 400 for determining the adhesion limit μₘₐₓ of any tire 100 fitted to a motor vehicle 405. The device 400 comprises a processing device 410 which comprises a programmable micro-computer 410 and which in particular can be designed to carry out the method 300 in whole or in part, In addition the device 400 comprises a first interface 415 for receiving a first value, a second interface 420 for receiving a second value, and preferably a third interface 425 for making available an adhesion limit μₘₐₓ determined. Some of the interfaces 415, 420 and 425 can even coincide or can be made integrally with one another. In one embodiment the two values for the interfaces 415 and 420 comprise a λ-value 150 and a coefficient of adhesion μ 210. In another embodiment other values are received, from which, as described earlier, the λ-value 150 and the coefficient of adhesion μ 210 can be determined. Thus, as described earlier, the adhesion limit μₘₐₓ is determined taking into account in which of the three ranges 215 to 225 the current λ-value 150 is located.

### INDEXES

100 Tire
105 Substrate
110 Circumferential speed
115 Longitudinal speed
120 Longitudinal direction
125 Slip
130 Rotational plane
135 Movement direction
140 Transverse direction
145 Sideslip angle
150 λ-value
200 Diagram
205 Characteristic curve
210 Coefficient of adhesion
215 First range
220 Second range
225 Third range
230 First threshold value
235 Second threshold value
240 Straight line through the origin
245 Tangent
250 Constant
255 Third threshold value (upper limit of 255 if needed)
300 Method
305 Detection
310 Determination of the instantaneous coefficient of adhesion
315 λ-value is in the first range
320 λ-value is in the second range
325 λ-value is in the third range
330 Determination of maximum coefficient of adhesion in relation to the slope of the straight line passing through the origin
335 Determination of maximum coefficient of adhesion in relation to the slope of the tangent
340 Determination of maximum coefficient of adhesion in relation to the maximum value
345 Make maximum coefficient of adhesion available
400 Device
405 Motor vehicle
410 Processing device
415 First interface
420 Second interface
425 Third interface

1-10. (canceled)

11. A method (300) for determining an adhesion limit (μₘₐₓ) between a tire (100) and a substrate (105) over which the tire (100) is rolling, in a longitudinal direction (120) of the tire (100), the method (300) comprising:
detecting (305) an instantaneous slip (125) of the tire (100);
determining (310) an instantaneous coefficient of adhesion (210);
forming (310) a tuple from the detected slip (125) and the instantaneous coefficient of adhesion;
determining (330) a maximum adhesion limit (μₘₐₓ) based on a slope (mᵤ) of a straight line from the origin (240) through the tuple, if the slip (125) is less than a predetermined first threshold value (230);
determining (335) the maximum adhesion limit (pmax) based on a tangential slope (mₜ) through the tuple, if the slip (125) is between the first threshold value (230) and a predetermined second threshold value (235); and
if the slip (125) is greater than the second threshold value (235), determining the maximum adhesion limit (μₘₐₓ) directly based on the coefficient of adhesion (210).

12. A method (300) for determining an adhesion limit (μₘₐₓ) between a tire (100) and a substrate (105) over which the tire (100) is rolling, in a transverse direction (140) of the tire (100), the method (300) comprising:
detecting (305) an instantaneous sideslip angle (145) of the tire (100);
determining (310) an instantaneous coefficient of adhesion (210);
forming (310) a tuple from the detected sideslip angle (145) and the instantaneous coefficient of adhesion (210) determined;
determining (330) a maximum adhesion limit (μₘₐₓ) based on a slope (mᵤ) of a straight line from the origin (240) through the tuple, if the slip (125) is less than a predetermined first threshold value (230);
determining (335) the maximum adhesion limit (μₘₐₓ) based on a tangential slope (mₜ) through the tuple, if the slip (125) is between the first threshold value (230) and a predetermined second threshold value (235);
if the sideslip angle (145) is above the second threshold value (235), determining (340) the maximum adhesion limit (μₘₐₓ) directly based on the effective instantaneous coefficient of adhesion (210).

13. The method (300) according to claims 11, further comprising if the slip (125) is greater than the predetermined second threshold value (235), determining the maximum adhesion limit (μₘₐₓ) as being equal to the instantaneous coefficient of adhesion (210).

14. The method (300) according to claim 11, further comprising , if the sideslip angle (145) is greater than the second predetermined threshold value (235), determining the maximum adhesion limit (μₘₐₓ) as being equal to the instantaneous coefficient of adhesion (210).

15. The method (300) according to claim 11, further comprising determining an instantaneous tangential force acting upon the tires (100) and the instantaneous coefficient of adhesion (210) as the quotient of the tangential force (140) and a normal force.

16. The method (300) according to claim 11, further comprising determining (310) the coefficient of adhesion (210) based on a model.

17. The method (300) according to claim 11, further comprising determining an instantaneous longitudinal force acting upon the tires (100) and the instantaneous coefficient of adhesion (210) as the quotient of the longitudinal force (120) and a normal force.

18. A device (400) for determination of a maximum adhesion limit (μₘₐₓ) between a tire (100) and a substrate (105) over which the tire (100) is rolling, in a longitudinal direction (120) of the tire (100), the device comprising:
a first interface (415) which detects an instantaneous slip (125) of the tire (100);
a second interface (420) which detects an instantaneous coefficient of adhesion (210);
a processing device (410) which is designed to form a tuple from the slip (125) detected and the coefficient of adhesion determined, and
determine the adhesion limit (μₘₐₓ) on a basis of the slope (mᵤ) of a straight line through the origin (240) passing through the tuple, if the slip (125) is lower than a predetermined first threshold value (230),
determine the adhesion limit (μₘₐₓ) on a basis of the slope (mₜ) of a tangent passing through the tuple, if the slip (125) is between the first threshold value (230) and a second threshold value (235), and
determine the adhesion limit (μₘₐₓ) directly on a basis of the coefficient of adhesion (210), if the slip (125) is greater than the second predetermined threshold value (235); and
a further interface (425) for making the determined adhesion limit (μₘₐₓ) available.

19. A device (400) for determination of a maximum adhesion limit (μₘₐₓ) between a tire (100) and a substrate (105) over which the tire (100) is rolling, in a transverse direction (140) of the tire (100), the device comprising:
a first interface (415) for detecting an instantaneous sideslip angle (145) of the tire (100);
a second interface (420) for detecting an instantaneous coefficient of adhesion (210);
a processing device (410) for forming a tuple from the sideslip angle (145) detected and the determined coefficient of adhesion (210); and
determine the adhesion limit (μₘₐₓ) on a basis of the slope (mᵤ) of a straight line through the origin that passes through the tuple, if the sideslip angle (145) is below a predetermined first threshold value (230),
determine the adhesion limit (μₘₐₓ) on a basis of the slope (mₜ) of a tangent passing through the tuple, if the sideslip angle (145) is between the first threshold value (230) and a second threshold value (235), or
determine the adhesion limit (μₘₐₓ) on a basis of the coefficient of adhesion (210), if the sideslip angle (145) is greater than the second predetermined threshold value (235), and
a further interface (425) for making available the adhesion limit (μₘₐₓ) determined.

20. A motor vehicle (405) in combination with the device according to claim 18, wherein the vehicle having the tire (100).

21. The method (300) according to claim 12, further comprising determining the maximum adhesion limit (μₘₐₓ) as being equal to the instantaneous coefficient of adhesion (210), if the slip (125) is greater than the predetermined second threshold value (235).

22. The method (300) according to claim 12, further comprising determining the maximum adhesion limit (μₘₐₓ) as being equal to the instantaneous coefficient of adhesion (210), if the sideslip angle (145) is greater than the second predetermined threshold value (235).

23. The method (300) according to claim 12, further comprising determining an instantaneous tangential force acting upon the tires (100) and determining the instantaneous coefficient of adhesion (210) as the quotient of the tangential force (140) and a normal force.

24. The method (300) according to claim 12, further comprising determining (310) the coefficient of adhesion (210) based on a model.

25. The method (300) according to claim 12, further comprising determining an instantaneous longitudinal force acting upon the tires (100) and the instantaneous coefficient of adhesion (210) as the quotient of the longitudinal force (120) and a normal force.
